(19) United States
(12) Patent Application Publication
(10) Pub. No.: US 2013/0173667 A1
(43) Pub. Date: Jul. 4, 2013

(54) ACYCLIC GRAPH NAVIGATOR

(71) Applicants: Eric Soderberg, Mountain View, CA (US); Steven Roth, Sunnyvale, CA (US)

(72) Inventors: Eric Soderberg, Mountain View, CA (US); Steven Roth, Sunnyvale, CA (US)

(21) Appl. No.: 13/822,606

(22) PCT Filed: Oct. 5, 2010
(86) PCT No.: PCT/US2010/051433

§ 371 Date: Mar. 12, 2013

(51) Int. Cl. G06F 17/30

(52) U.S. Cl. CPC G06F 17/30958
USPC 707/798

(57) ABSTRACT

A method for navigating an acyclic graph includes the steps of generating two or more acyclic graphs, each of the two or more acyclic graphs relating to a specific topology, wherein at least two of the two or more acyclic graphs include at least one common node; receiving a request to generate a composite acyclic graph, wherein the composite acyclic graph includes the at least one common node; generating the composite acyclic graph; and displaying the specific node of the composite acyclic graph.

### BACKGROUND

A graph can be considered to consist of a number of nodes, or vertices and a number of edges, or arcs, that connect those nodes. An acyclic graph can be directed or undirected. In a directed acyclic graph, the direction of motion between vertices is pre-determined, much like a one-way street. An acyclic graph has no cycles, meaning that when progressing from one node to another following a sequence of edges, one can never loop back or cycle back to the original node following a different sequence of edges. Thus, with an acyclic graph, directed or undirected, there is no way to start at a node 1 and follow a sequence of edges that eventually loops back to node 1.

A directed acyclic graph (sometimes referred to as a DAG) may be used to represent a network of processing elements; in this formulation, data enters a processing element through its incoming edges and leaves the element through its outgoing edges. For example, in electronic circuit design, a combinational logic circuit is an acyclic system of logic gates that computes a function of an input, where the input and output of the function are represented as individual bits. In another example, a Bayesian network can be used to represent a system of probabilistic events as nodes in a directed acyclic graph. The likelihood of an event may be calculated from the likelihoods of its predecessors in the directed acyclic graph. In yet another example an acyclic graph can be used to represent a system of related values in a data flow programming language. When one value changes, its successors are recalculated; each value is evaluated as a function of its predecessors in the directed acyclic graph.

In another example of acyclic graphs, an enterprise may use multiple acyclic graphs to represent different data topologies that are relevant to the enterprise. As the number of such graphs, and the data that populates them increases, navigation of such multiple topologically distinct acyclic graphs becomes difficult, in part because existing management tools often are oriented around a single primary topology, making navigation of other relevant topologies difficult or impossible. Such existing management tools also make display of relevant information from the acyclic graphs difficult and hard to understand. More specifically, acyclic graphs may resemble an inverted tree structure. Existing management tools often use a tree control for topology navigation (i.e., moving from node to node in the tree structure), and trees are inefficient mechanisms for displaying and navigating large topologies because they can grow to the point where large amounts of scrolling are required to view the entire tree structure. Furthermore, tree structures cannot display information about non-tree graphs well (i.e., those in which nodes can have multiple parents). For example, if a tree is used to display a power topology, it is likely that the same node will exist in multiple places in the same tree, under each power source, which can cause confusion for users.

### DESCRIPTION OF THE DRAWINGS

The Detailed Description will refer to the following drawings in which like numerals refer to like items, and in which:

FIG. 1 illustrates an environment in which an embodiment of an acyclic graph navigator is implemented;

FIG. 2 is a block diagram of an embodiment of an acyclic graph navigator;

FIGS. 3 and 4 illustrate graphical user interface display embodiments generated by the acyclic graph navigator of FIG. 2;

FIG. 5 is a flowchart illustrating an embodiment of an operation of the acyclic graph navigator of FIG. 2 as implemented in the environment of FIG. 1; and

FIG. 6 is a flowchart illustrating an embodiment of another operation of the acyclic graph navigator.

### DETAILED DESCRIPTION

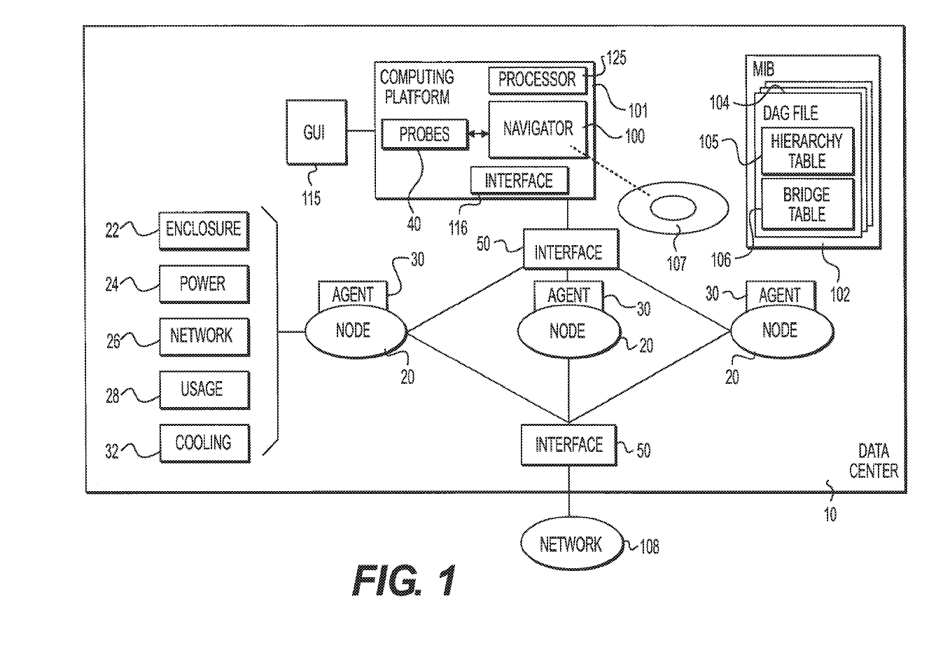

FIG. 1 illustrates an environment in which an embodiment of an acyclic graph navigator may be implemented. FIG. 1 shows a large data center 10 having a number of components 20. The components 20 may communicate internally within the data center 10 or externally to and from network 108 through interfaces 50. The components 20 may include processors and storage devices instantiated on blades that are housed in enclosures or racks, rooms, and buildings, and that receive power for operations, cooling air, network connectivity, and data from sources external to and internal to the data center 10. The data center 10 may contain many thousands of processors and storage devices. As part of the data center 10, computing platform 101 includes acyclic graph navigator 100, and connections to management information base (MIB) 102 and graphical user interface 115. The MIB 102 may contain data related to the data center components 20; the data may be stored in acyclic graph files 104 within the MIB 102. The acyclic graph files 104 may include specific data structures, including hierarchy tables 105 and bridge tables 106. Other data structures may be stored in the MIB 102. The navigator 100 may be implemented as programming on a non-transitory computer-readable medium 107 that is used to load the navigator 100 onto the computing platform 101. Alternately, the navigator 100 may come pre-loaded into main memory of the computing platform 101 when the computing platform 101 is installed in the data center 10. The navigator 100 is loaded into RAM, or equivalent, upon boot up of the computing platform 101 operating system.

The computing platform 101 also includes processor 125 and an input device such as a keyboard, mouse, or touch screen (not shown). The computing platform 101 as disclosed herein is intended to encompass a personal computer, workstation, server network computer, mainframe or any other suitable processing device. The computing platform 101 may execute any operating system including UNIX, WINDOWS™, Linux, and others. FIG. 1 provides one example of a computing platform that may be used with the herein disclosed inventions. The present disclosure contemplates computers other than general purpose computers as well as computers without conventional operating systems.

Graphical user interface (GUI) 115 comprises, at least, a graphic user interface operable to allow a human user of computing platform 101 to interact with one or more processes executing on computing platform 101. Generally, the GUI 115 provides the user of computing platform 101 with an efficient and user-friendly presentation of data provided by computing platform 101 or network 108. The GUI 115 may provide a number of displays having interactive fields, pull-down lists, and buttons operated by the user. In one example, the GUI 115 presents an explorer-type interface and receives commands from the user. As used herein, the term graphical user interface may be used in the singular or in the plural to describe one or more graphical user interfaces and each of the displays of a particular graphical user interface. Further, the GUI 115 contemplates any graphical user interface, such as a generic web browser, that processes information in computing platform 101 and efficiently presents the information to the user. Network 108 can accept data from the user of computing platform 101 by way of a Web browser (e.g., MICROSOFT™ INTERNET EXPLORE™ or NETSCAPE™ NAVIGATOR™) and return the appropriate HTML, JAVA™, or eXtensible Markup Language (XML) responses.

Computing platform 101 may include an interface 116 for communicating with other computer systems over the network 108 such as, for example, in a client-server environment or other distributed environments. The network 108 facilitates wireless or wireline communication between computing platform 101 and any other computer. Devices on the network 108 may communicate by, for example, Internet Protocol (IP) packets, Frame Relay frames, Asynchronous Transfer Mode (ATM) cells, voice, video, data, and other suitable information between network addresses. The network 108 may include one or more local area networks (LANs), radio access networks (RANs), metropolitan area networks (MANs), wide area networks (WANs), all or a portion of the global computer network known as the Internet, and/or any other communication system or systems at one or more locations. The interface 116 includes logic encoded in software and/or hardware in a suitable combination and operable to communicate with the network 108. More specifically, the interface 116 may comprise software supporting one or more communications protocols associated with network 108 hardware operable to communicate physical signals.

The MIB 102 may include any memory, hard drive, or database module and may take the form of volatile or non-volatile memory including, without limitation, magnetic media, optical media, random access memory (RAM), read-only memory (ROM), removable media, or any other suitable local or remote memory component. Illustrated MIB 102 stores, or includes references to, one or more acyclic graph files 104. Generally, each acyclic graph file 104 is a data structure including at least one directed acyclic graph object of any appropriate data type. For example, acyclic graph files 104 may include one or more tables 105, 106 stored in a relational database described in terms of SQL statements or scripts. In another embodiment, the acyclic graph files 104 may store or define the acyclic graph objects as XML documents, flat files, Btrieve files, or comma-separated-value (CSV) files. Alternately, the graph may not be stored in a file at all, but rather is computed in memory when needed based on information contained in other forms. While each acyclic graph file 104 may include more than one acyclic graph object, the terms acyclic graph file and acyclic graph object may be used interchangeably, as appropriate, without departing from the scope of this disclosure. Each acyclic graph file 104 is a logical graph where no path begins and ends at the same vertex (hence “acyclic”) such as, for example, XML tree structures, array trees, list structures, and others. The acyclic graph file 104 includes at least one logical node of any of a number of data types. The MIB 102 may include any other suitable data or module without departing from the scope of this disclosure.

The navigator 100 may be written or described in any appropriate object-oriented or aspect-oriented computer language, including C, C++, JAVA™, Smalltalk, any suitable version of 4GL, and others. Further, while the navigator 100 is illustrated as a single multi-tasked module, the features and functionality performed by this module may be performed by multiple modules. Moreover, while not illustrated, the navigator 100 may be a sub-module of another module without departing from the scope of this disclosure.

The navigator 100 is used to explore an acyclic graph that may be constructed from the acyclic graph files 104 and the corresponding hierarchy tables 105. One problem with using hierarchy tables, such as the tables 105, to construct an acyclic graph is that to find all descendants of a given node, in the prior art, a software program would normally be used to execute a recursive operation starting with the given node (e.g., a root node) and progressing through all descendant nodes. Such recursive operations are processor-intensive and slow in real time. One solution to this recursive operation is to use a bridge table, such as the bridge table 106, which stores ancestor and descendant relationships for a given node simultaneously, allowing determination of ancestors or descendants with a simple, non-recursive operation. Note that as used herein, the term ancestors will include parents (first generation ancestors) and grandparents (second generation ancestors), etc., and the term descendents will include children (first generation) and grandchildren (second generation), and so on. Thus, to create an acyclic graph, or a portion of an acyclic graph, a software routine, or algorithm, may recursively search a hierarchy table for each node, identifying ancestor and descendant nodes. Because this recursive operation is time consuming, especially for large data structures, the navigator 100 uses bridge table 106, which may be constructed from its corresponding hierarchy table 105 using an appropriate algorithm, to identify ancestor and descendent nodes for each specific node. The bridge table 106 allows a graphing engine within the navigator 100 to quickly discover and display the desired node, and its ancestor and descendent nodes. However, to complicate matters, an environment such as the data center 10 contains many different topologies, each of which may be defined as a separate acyclic graph, and some of which contain identical nodes. Thus, with the example of the data center 10, there may be multiple, overlapping acyclic graphs that can be generated from multiple hierarchy tables. The navigator 100 disclosed herein allows the display of a single node, which exists in multiple topologies, selected for example by a human user, and all the multiple ancestor (in part because there are multiple topologies) and multiple descendent nodes associated with (connected by edges) the selected node.

As noted, the data center 10 includes a number of topologies. As can be seen conceptually in FIG. 1, these topologies include, for example, an enclosure topology 22, a power topology 24, a network topology 26, a usage topology 28, and a cooling topology 32. The data center 10 may include a number of other topologies; however, the listed example topologies will illustrate the principles of the acyclic graph navigator 100.

The enclosure topology 22 relates to the physical enclosures in which components of the data center are housed. Such enclosures include, for example, blades that house various processors and storage devices, racks that hold the various blades; and buildings that house the racks.

The power topology 24 is essentially a power distribution grid that illustrates power sources, wiring, breakers, outlets, etc. for each of the processors, blades, racks, and buildings in the data center 10. Unlike some topologies, the power topology may exist with nodes having more than one ancestor. This multi-parent arrangement of the topology 24 reflects a redundancy of the power supplies among the components 20. However, any graph of the power supply topology still will be acyclic.

The network topology 26 relates the various network connections available into and out of the data center 10, as well as the intra-center network connections to individual processors, and their supported applications.

The usage topology 28 relates various applications that may execute on one or more processors to the specific processors assigned for execution of those applications.

The cooling topology 32 relates to cooling air supplied to various components (buildings, rooms, enclosures, servers) in the data center 10.

In an improvement over existing graph exploration tools, the acyclic graph navigator 100 is designed to allow navigation of up to all five topologies 22, 24, 26, 28, and 32 simultaneously. One skilled in the art will recognize, of course, that the navigator 100 will allow navigation to any number of topologies, not just the five topologies 22, 24, 26, 28, and 32.

A data center administrator or engineer may, from time to time, want or need to examine the various relationships represented by the topologies 22, 24, 26, 28, and 32. For example, a system administrator may need to monitor execution of applications by assigned processors. A HVAC engineer may need to monitor cooling of various data center components. These topologies my be represented in an acyclic graph. The acyclic graph may be directed or undirected. An example of an undirected acyclic graph is a tree structure. A tree structure is simply an acyclic graph whose nodes are all reachable from some starting node and one that has no cycles. Thus, some data center topologies may be represented in a tree structure, and a corresponding management tool then can be used to navigate the tree structure to examine individual nodes within the tree structure. Other topologies, for example a power topology, which can have multiple parents, cannot be represented by a tree structure.

To view the various relationships of a node represented by the topologies, the connections between the node and its ancestor and descendent nodes are retrieved from the MIB 102. Once retrieved, the nodes can be displayed to a user by way of a user interface, such as the GUI 115. An associated management tool (e.g., the navigator 100) then can be used to navigate the various nodes and edges represented in the tree structure. As noted above, prior art graph exploration tools are designed to show a single topology. In addition, these prior art tools do not scale well in terms of usability for handling large or deep hierarchies represented in the tree structure. That is, large hierarchies require a great deal of vertical scrolling and deep hierarchies require a great deal of horizontal scrolling.

Operation of the navigator 100 may be based, in an embodiment, on the development of an object-oriented structure representing the various components and functions of the data center 10. Referring to FIG. 1, the object-oriented structure may be created, in part, by the use of intelligent agents 30 distributed throughout the data center 10 (i.e., at components 20). The agents 30 autonomously gather and process data from one or more of the data center components 20, and provide either raw or processed data to computing platform 101. In addition, the computing platform 101 can control probe daemons 40 for executing ad hoc data collection. The data gathered by the agents 30 and probes 40 is used to partly populate the management information base (MIB) 102.

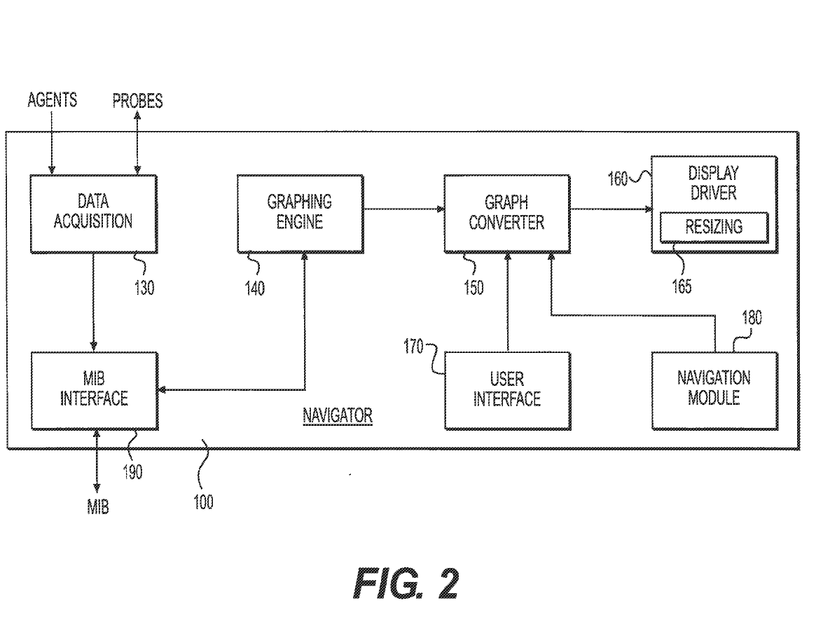

FIG. 2 illustrates in block diagram format, an embodiment of the acyclic graph navigator 100 of FIG. 1. As noted above, the navigator 100 may be implemented as programming on a non-transitory computer-readable medium 107 that is used to load the navigator 100 onto the computing platform 101. Alternately, the navigator 100 may come pre-loaded into main memory of a computing platform, and the navigator 100 is loaded into RAM, or equivalent, upon boot up of the computing platform's operating system. Also, the navigator 100 is shown to include a number of discrete modules. However, the actual arrangement of modules is for illustration only, and other arrangements of modules within the navigator 100 are possible. In addition, the functions of some modules may be provided by modules outside the navigator 100.

In FIG. 2, navigator 100 is seen to include data acquisition module 130, graphing engine 140, graph converter 150, display driver 160, user control module 170, navigation module 180, and MIB interface 190. The display driver 160 includes resizing module 165. The MIB interface 190 allows the data collected by the data acquisition module 130 to be fed into the graphing engine 140. Data processed in the MIB interface 190 can be sent to and stored in the MIB 102. The MIB interface 190 also extracts data from the MIB 102 and sends the extracted data to the graphing engine 140.

The data acquisition module 130 receives data from the intelligent agents 30 and directs the probes 40 to acquire information, which the module 130 then receives. For example, the data acquisition module 130 may direct probes 40 to acquire information for repopulating hierarchy tables 105 upon a change of the data center components 20. Alternately, the components 20 may automatically acquire and report this information upon a change to the components 20.

The graphing engine 140 takes hierarchy data from the MIB 102 and prepares a graphical representation of the data in the form of an acyclic graph. The graphing engine 140 may store a current version of the acyclic graph so that it can be displayed to a user. As changes are made to the hierarchy table in the MIB 102, the acyclic graph in graphing engine 140 also is changed, for example, during the same transaction that updated the hierarchy table (i.e., if a server blade is added to the data center 10, the hierarchy table 105 in the MIB 102 and the acyclic graph corresponding to that hierarchy table 105 both are updated).

The graph converter 150 converts the acyclic graph generated by the graphing engine 140 into a visual display that can be understood and manipulated by the user. More importantly, the graph converter 150 takes a number of overlapping acyclic graphs, one of each topology, and forms a composite acyclic graph display of ancestors and descendents for the nodes. The graph converter 150 also provides an optional animation function such that when a selected node is changes, the recomputation and display of “new” ancestor and descendent nodes is animated, with, for example, the “old” ancestor and descendent nodes fading out, or moving and the “new” ancestor and descendent nodes coming into view over a finite time such as, for example, five seconds. Thus the selected node, and the corresponding ancestor and descendent nodes may be seen to move over time to allow the user to better understand the displayed changes.

The visual display is physically presented to the user using display driver 160, which sends visual displays of the composite acyclic graph to a display device, such as a flat screen monitor of a computer. One such display is a compact composite acyclic graph showing ancestors and descendents, but without indicating topologies. Another such display is a composite acyclic graph segment illustrating a specific node, the node's ancestor and descendent nodes, and the topological relationships, or edges, among the nodes. In an embodiment, only a subset of available topologies is used. Also in an embodiment, both the compact composite acyclic graph and the composite acyclic graph segment may be presented simultaneously.

The composite acyclic graph segment may include enough nodes such that the segment will exceed the horizontal and/or vertical capacity of the display device on which the segment is displayed. To avoid a need for horizontal and/or vertical scrolling, the resizing module 165 may be used to resize the segment, using one or more truncation routines, or resizing routines that include reducing the scale of the displayed nodes. The resizing module 165 may execute its functions automatically, whenever the segment exceeds the display capacity of the display device. Alternately, the resizing function may be executed manually, under control of a human user. The resizing module 165 may select a resizing routine that most efficiently resizes the segment to fit the available display device without the need for scrolling. One such routine is a truncation routine that involves replacing a list of like components (e.g., servers) with a single label and the number of such components: server (22) indicating 22 servers as descendent nodes.

User interface 170 provides controls that allow the user to manipulate data used in generating the visual display of the acyclic graph. For example, the user interface 170 may allow the user to view a subset of the available topologies.

Navigation module 180 allows the user to select different starting nodes and different levels within the data hierarchy represented in the composite acyclic graph. When the user selects a different starting node, the ancestors (because the display is multi-topological) and the descendents of that new starting node are displayed, along with the edges connecting the nodes.

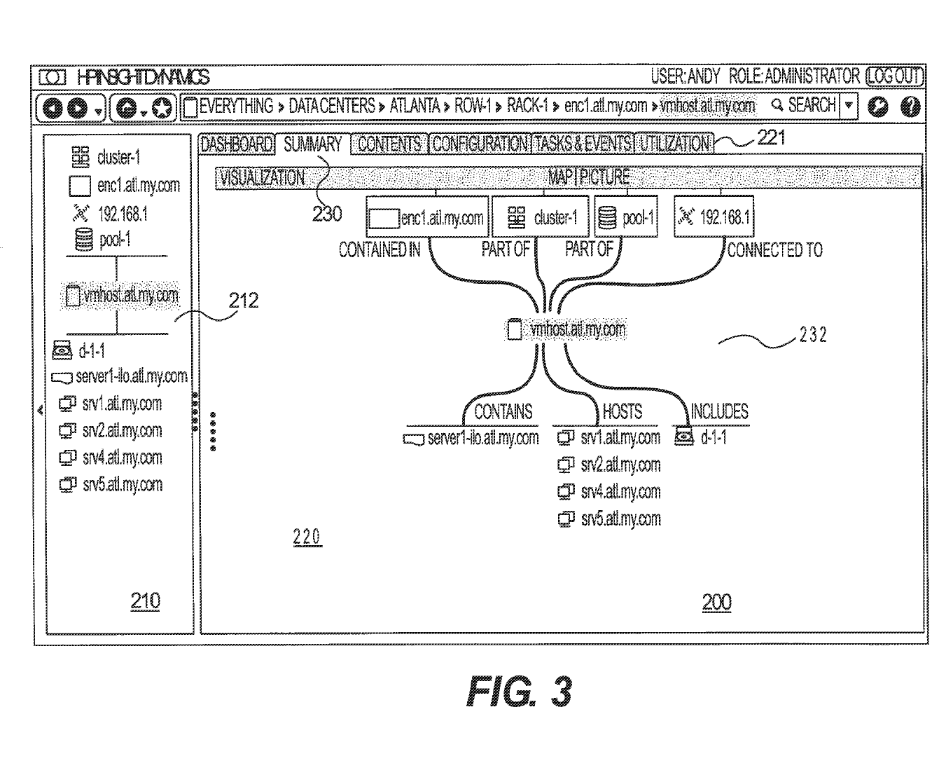

FIG. 3 shows an embodiment of a user interface generated by operation of the navigator 100. In FIG. 3, user interface 200 includes summary area 210 and main area 220. The summary area 210 displays, in a high-level view, a compact structure 212 representing the composite acyclic graph derived from the multiple hierarchy tables 105 and bridge tables 106. Each displayed node in the tree structure 212 may be selected, and this selection will reveal any subordinate or descendent nodes. In addition, by selecting one of the displayed nodes from the structure 212, the navigator 100 is directed to provide data for display in the main area 220. The main area includes tabs 221, which, when selected, change the display available in the main area 220. For example, summary tab 230 provides a visual composite view (i.e., a composite graph segment) 232 of the nodes from the compact tree structure shown in the summary area 210. As shown in the example of FIG. 3, node vmhost1.atl.my.com has six descendent nodes and four ancestor nodes. In an embodiment, when the summary tab 230 is selected, a composite graph segment is displayed. The composite graph segment may be truncated horizontally and vertically to fit the available display without scrolling. The composite graph segment 232 shows disk drive d-1-1 as included in the node vmhost1.atl.my.com, and the node vmhost1.atl.my.com hosting four separate servers, as well as containing node server9-ilo.atl.my.com. If a user selects any of the ancestor nodes shown in the composite graph segment 232, the navigator 100 will repopulate the main area 220 with a new composite graph segment showing the selected ancestor node in the middle of the new composite graph segment, and with its own ancestor and descendent nodes (one of the descendent nodes being, of course, node vmhost1.atl.my.com). Similar to scrolling through the composite view in the main area 220, by scrolling through the structure 212 in the summary area 210, the user can cause the navigator 100, in an animated fashion, to repopulate the main area 220 with a new composite graph segment, and retaining the user's context.

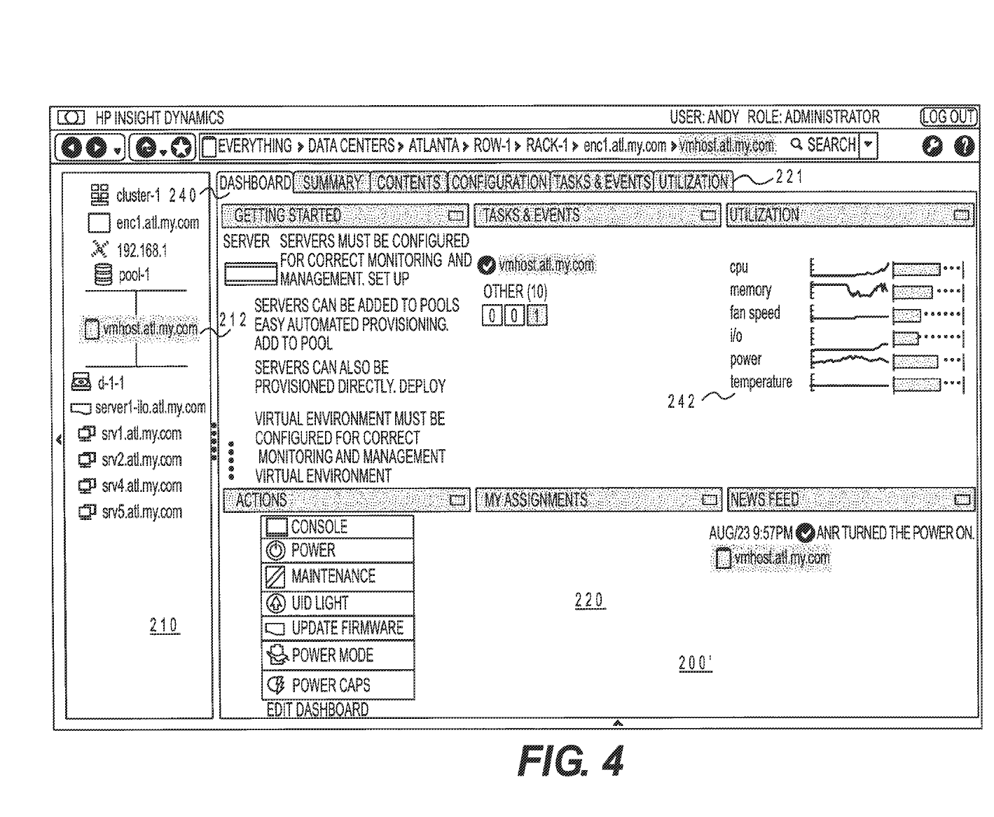

FIG. 4 shows an embodiment of another user interface 200′ generated by operation of the navigator 100. In FIG. 4, dashboard tab 240 is shown selected, and the main area 220 now shows various types of summary information, including utilization data in window 242. As the selected node in the summary area 210 is changed, the data in the main area, with the dashboard tab 240 selected, changes to reflect data appropriate to the selected node.

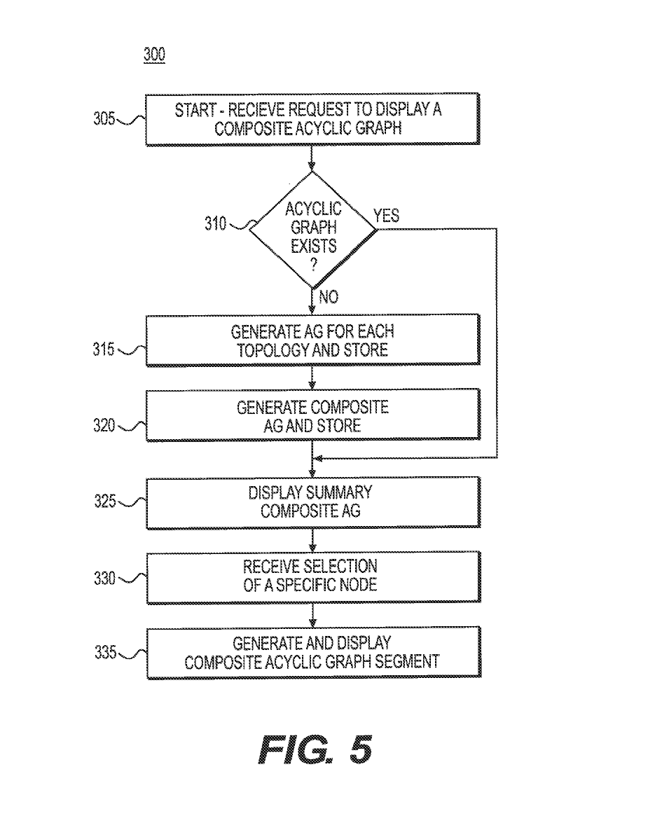

FIG. 5 is a flowchart illustrating an embodiment of an operation of the acyclic graph navigator 100 of FIG. 2 as implemented in the environment of FIG. 1. Generally, illustrated operation 300 includes determining the structure of each acyclic graph (one for each topology), processing each node to determine its ancestors and descendents, and combining the acyclic graphs to present a composite view of each node across all appropriate topologies. The following description will focus on the operation of acyclic graph navigator 100 and its component modules in executing the operation 300. However, any appropriate combination and arrangement of logical elements may be used when implementing some or all of the described functions and method steps.

In FIG. 5, operation 300 begins in block 305 when the navigator 100 receives a request to display one or more topologies related to the data center 10. Such display will be in the form of an acyclic graph, and more particularly a tree structure. The request may be initiated by a human user; alternately, the request may be generated automatically by a module of the navigator 100, or otherwise by a component of the computing platform 101, for example, when one or more of the hierarchy tables 105 are updated.

In block 310, the navigator 100 determines if the composite acyclic graph exists and is current. If the composite acyclic graph is current, the operation 300 moves to block 325. However, in block 310, if the composite acyclic graph does not exist or is not current, the operation 300 move to block 315 and the navigator 100 generates a current acyclic graph for one or more topologies using the acyclic graph files 104, and in particular the bridge tables 106, to identify ancestor and descendent nodes for each node in the hierarchy tables 105. In block 320, the navigator 100 generates a composite acyclic graph and stores the newly created composite acyclic graph in the MIB 102.

In block 325, the navigator 100 displays a compact composite acyclic graph and an acyclic graph segment centered on a selected node, if applicable. In block 330, the navigator 100 receives a selection of a specific node for which a composite acyclic graph segment is to be displayed. In response to the request of block 330, the navigator 100 searches the composite acyclic graph for an instance of the requested node, and all ancestor and descendent nodes. In block 335, the navigator 100 generates and displays a composite graph segment of the requested node along with its ancestor and descendent nodes.

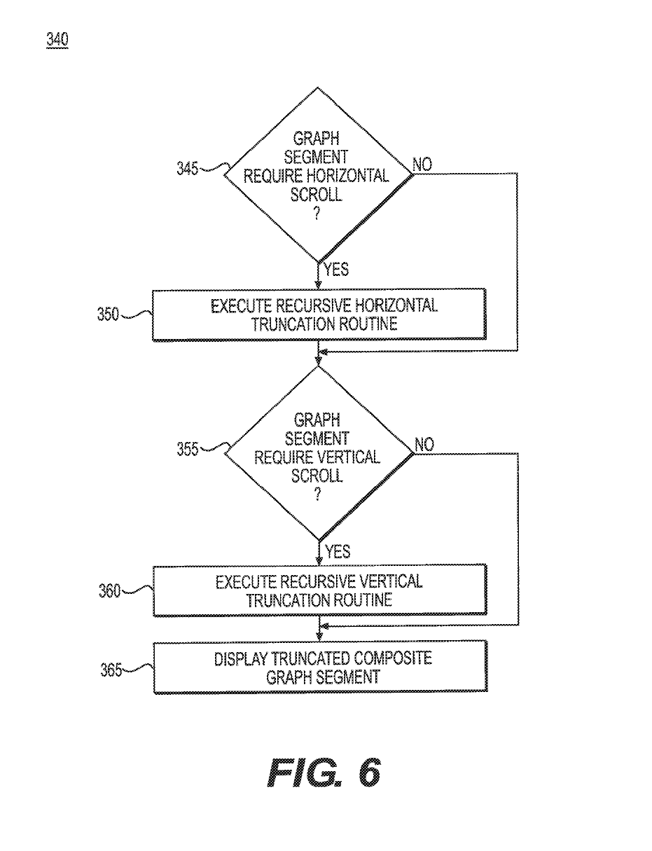

The composite graph segment may be resized, using one or more routines, so that the segment fits the available display device without the need for scrolling, of for limited scrolling. FIG. 6 illustrates an embodiment of a resizing (truncation) operation 340. In block 345, the navigator 100 determines if the composite graph segment requires horizontal scrolling. If no horizontal scrolling is required, the operation 340 moves to block 355. If horizontal scrolling is required, the navigator 100 executes an appropriate horizontal truncation routine, block 350. In block 355, the navigator 100 determines if the composite graph segment requires vertical scrolling. If vertical scrolling is not required, the operation 340 moves to block 365. If vertical scrolling is required, the operation 340 moves to block 360 and the navigator 100 executes an appropriate vertical truncation routine. In block 365, the navigator 100 displays the truncated composite graph segment.

We claim:

1. A method for navigating an acyclic graph, comprising:
generating two or more acyclic graphs, each of the two or more acyclic graphs relating to a specific topology, wherein at least two of the two or more acyclic graphs comprise at least one common node;
receiving a request to generate a composite acyclic graph, wherein the composite acyclic graph comprises the at least one common node;
generating the composite acyclic graph; and
displaying a graph segment comprising a specific node of the composite acyclic graph.

2. The method of claim 1, further comprising generating each of the one or more acyclic graphs based on a hierarchy table, and wherein receiving the request to generate the composite acyclic graph comprises changing data in at least one of the hierarchy tables.

3. The method of claim 1, further comprising displaying a compact composite acyclic graph.

4. The method of claim 3, further comprising displaying the specific node in the compact composite acyclic graph.

5. The method of claim 1, further comprising:
receiving a request to navigate the composite acyclic graph by selecting one of a displayed ancestor or descendent node;
in response to the navigate request, recomputing ancestor and descendent nodes for the selected node; and
displaying the selected node and the recomputed descendent and ancestor nodes.

6. The method of claim 5, wherein the displaying is animated.

7. The method of claim 5, wherein displaying the specific node and the ancestor and descendent nodes comprises displaying the specific node with the ancestor nodes above and the descendent nodes below the specific node and wherein one or more of the acyclic graphs comprises nodes having a plurality of parent nodes.

8. The method of claim 5, wherein displaying the specific node and the ancestor and descendent nodes comprises displaying edges connecting the specific node and the ancestor and descendent nodes.

9. The method of claim 5, wherein displaying the ancestor and descendent nodes comprises displaying a subset of the ancestor and descendent nodes.

10. The method of claim 5, wherein a number of ancestor nodes and descendent nodes exceeds a designated display device capacity, further comprising reducing the displayed nodes to fit the designated display device capacity.

11. The method of claim 10, wherein reducing the displayed nodes comprises truncating one or more of the ancestor nodes and the descendent nodes of the graph segment to create a truncated graph segment such that the truncated graph segment matches the designated display device capacity.

12. An acyclic graph navigator, comprising:
a graphing module that generates a plurality of acyclic graphs, each acyclic graph related to a specific topology;
a graph converter that combines two or more of the acyclic graphs to generate a composite acyclic graph;
a display module that generates a graph segment comprising a selected node of the composite acyclic graph, and multiple ancestor and descendent nodes of the selected node, and further comprising edges linking the selected node and the ancestor and descendent nodes, and provides a display of the graph segment using a user interface; and
a navigation module that accepts alternate node selections and provides instructions to the display module to generate an alternate graph segment based on the selected alternate node.

13. The acyclic graph navigator of claim 12, wherein the display module comprises a resizing module, the resizing module including a plurality of truncation routines and scaling routines, wherein one or more of the truncation routines and rescaling routines operate in the graph segment such that the graph segment is sized to fit an available display device without scrolling.

14. The acyclic graph navigator of claim 1, wherein the display module provides a compact composite acyclic graph comprising the selected node and each of the ancestor and descendent nodes, and wherein the alternate node selection is made from one of the summary composite graph and the graph segment, and wherein selection of the alternate node causes the display module to center the alternate node below its corresponding ancestor nodes and above its corresponding descendent nodes.

15. The acyclic graph navigator of claim 12, wherein the each of the acyclic graphs is based on an associated hierarchy table, and wherein the graphing module automatically updates the acyclic graphs upon changes to the associated hierarchy tables.
